(19) United States
(12) Patent Application Publication
(10) Pub. No.: US 2011/0218262 A1
(43) Pub. Date: Sep. 8, 2011

(54) PREPARING RIGID POLYURETHANE FOAMS

(75) Inventors: Berend ELING, Lemforde (DE); Markus SCHÜTTE, Osnabruck (DE); Sirus ZARBAKHSH, Hong Kong (HK); Holger SEIFERT, Bohmte (DE); Gunnar KAMPF, Stemwede-Haldem (DE)

(73) Assignee: BASF SE, Ludwigshafen (DE)

(21) Appl. No.: 13/037,983

(22) Filed: Mar. 1, 2011

Related U.S. Application Data
(60) Provisional application No. 61/309,473, filed on Mar. 2, 2010.

(51) Int. Cl. C08G 18/32; C08J 9/14

(52) U.S. Cl. 521/131; 521/174; 521/175; 521/164

(57) ABSTRACT

The invention relates to a process for preparing rigid polyurethane foams, which comprises reacting
a) polyisocyanates with
b) compounds having at least two hydrogen atoms reactive with isocyanate groups in the presence of
c) blowing agents,

wherein said compounds having at least two hydrogen atoms reactive with isocyanate groups b) comprise at least one polyether alcohol b1) having a functionality of 2-8 and a hydroxyl number of 200-800 mgKOH/g, obtained by addition of an alkylene oxide b1b) onto a compound having at least two hydrogen atoms b1a), hereinafter also known as starter substances, reactive with alkylene oxides by using an amine b1c) as catalyst.

The present invention relates to a process for preparing rigid polyurethane foams by reaction of polyisocyanates with compounds having at least two hydrogen atoms reactive with isocyanate groups in the presence of blowing agents.

Rigid polyurethane foams are long known and are predominantly used in heat and cold insulation, e.g., in refrigeration appliances, in hot water storage systems, in district heating pipes or in building construction, for example in sandwich elements. A summarizing overview of the production and use of rigid polyurethane foams may be found for example in Kunststoff-Handbuch, volume 7, Polyurethanes 1st edition 1966, edited by Dr. R. Vieweg and Dr. A. Höchtlen, and 2nd edition 1983, edited by Dr. Günter Oertel, and 3rd edition 1993, edited by Dr. Günter Oertel, Carl Hanser Verlag, Munich, Vienna.

Blowing agents used for producing rigid polyurethane foams used to be mainly chlorofluorocarbons (CFCs), preferably trichlorofluoromethane. These blowing gases have an adverse impact on the environment, however.

Hydrocarbons, preferably pentanes, have now come to be mostly used as successors to the CFCs. EP-A-421 269 describes the use of cyclopentane and/or cyclohexane, optionally in admixture with other hydrocarbons, as blowing agents.

However, these blowing agents differ from the halogenated blowing agents in various respects. They are less compatible with the other constituents of the polyurethane systems. This leads to rapid separation of the components comprising blowing agents.

Not as much blowing agent can be incorporated in the components. Therefore, foams blown with alkanes usually have a higher density than foams blown with CFCs.

Therefore, there is a need to reduce the density of the foams in order to save material without, however, sacrificing the thermal conductivity or the mechanical properties of the polyurethanes. When hollow spaces such as housings of refrigeration appliances are filled with foam, the hollow space should be filled uniformly, i.e., the liquid reactive components shall flow into all parts of the hollow space. If the flowability of the foam is insufficient, hollow spaces having a large volume and/or complicated geometry need to be overfilled with foam so that the pressure build-up may ensure uniform distribution of the foam. The better the liquid reactive components fill the hollow spaces, the less the quantity needed of the rigid polyurethane foam to completely fill the hollow space with foam. As a result, the rigid polyurethane foam in the hollow space has a lower density, leading to a reduction in the weight of the end products, for example refrigeration appliances, as well as a saving of material.

Foam flowability herein is to be understood as referring to the flow behavior of the reacting mixture of polyisocyanate and the compound having at least two hydrogen atoms reactive with isocyanate groups. Flowability is usually determined by determining the distance covered by the reacting mixture. This can be done by introducing the reaction mixture into a flexible tube of polymer film, hereinafter referred to as the tube test, or into a standardized elongate mold, for example a so-called Bosch lance, and determining the length of the molded article thus formed.

The flowability of the reaction mixtures is typically determined by determining the flow factor. The flow factor is the ratio of the minimum fill density to the free-foamed envelope density, and is determined by means of the Bosch lance. The minimum fill density is obtained by varying the shot weight and corresponds to the minimum density needed to completely fill a Bosch lance for a given free envelope density.

It is an object of the present invention to provide a process for preparing rigid polyurethane foams wherein the polyol components have better solubility for the hydrocarbons used as blowing agents. Improved processing properties should also be achieved, more particularly an improved flowability. In addition, foams having good mechanical properties and low thermal conductivities should be obtained.

We have found that this object is achieved, surprisingly, by the use of polyols prepared by addition of alkylene oxides onto compounds having at least two active hydrogen atoms in the presence of at least one compound having at least one amino group as catalyst.

Compounds prepared by addition of alkylene oxides onto compounds having at least two active hydrogen atoms in the presence of at least one compound having at least one amino group as catalyst are known.

US 20070203319 and US 20070199976 describe polyether alcohols obtained by addition of alkylene oxides by means of dimethylethanolamine onto starter substances comprising solid compounds at room temperature. However, polyurethanes obtained using these polyols are not described. Nor does this document include any clue to the properties of the described polyols in the preparation of foams and their effects on the properties of foams.

The present invention provides a process for preparing rigid polyurethane foams, which comprises reacting
a) polyisocyanates with
b) compounds having at least two hydrogen atoms reactive with isocyanate groups in the presence of
c) blowing agents,
   wherein said compounds having at least two hydrogen atoms reactive with isocyanate groups b) comprise at least one polyether alcohol b1) having a functionality of 2-8 and a hydroxyl number of 200-800 mgKOH/g, obtained by addition of an alkylene oxide b1b) onto a compound having at least two hydrogen atoms b1a), hereinafter also known as starter substances, reactive with alkylene oxides by using an amine b1c) as catalyst.

The polyether alcohol b1) can be used as sole compound of component b).

Preferably, the polyether alcohol b1) is used in an amount of 10-90% by weight, based on the weight of component b).

Preferably, the compound having at least two hydrogen atoms reactive with alkylene oxides used for preparing the polyether alcohol b1) comprises a mixture comprising at least one compound b1ai) which is solid at room temperature. The compound b1ai) preferably has a functionality of at least 3, more preferably of at least 4, even more preferably of 3-8 and yet even more preferably of 4-8.

Compounds b1ai) of this type are known and are frequently used in the manufacture of polyether alcohols, particularly those for use in rigid polyurethane foams. The compounds b1ai) are preferably selected from the group comprising trimethylol-propane, pentaerythritol, glucose, sorbitol, mannitol and sucrose, polyhydric phenols, resols, for example oligomeric condensation products of phenol and formaldehyde, oligomeric condensation products of aniline and formaldehyde (MDA), toluenediamine (TDA) and Mannich condensates of phenols, formaldehyde and dialkanolamines, and also melamine and also mixtures of at least two of the alcohols listed.

In a preferred embodiment of the invention, compound b1ai) is selected from the group comprising sucrose, sorbitol and pentaerythritol, more preferably sucrose or sorbitol. In a particularly preferred embodiment of the invention, b1a) is sucrose.

The aromatic amines used as compounds b1ai) are more particularly selected from the group comprising toluenediamine (TDA) or diphenylmethanediamine (MDA) or polymeric MDA (p-MDA). In the case of TDA it is more particularly the 2,3- and 3,4-isomers, also known as vicinal TDA, which are used.

Useful starter substances further include compounds b1a) having at least two hydrogen atoms reactive with alkylene oxides that comprise at least one compound b1aii) which is liquid at room temperature.

In a preferred embodiment of the invention, the starter substance of component b1) comprises a room temperature liquid compound b1aii) comprising hydrogen atoms reactive with alkylene oxides as well as the compound b1ai). The compound b1aii) may comprise alcohols or amines. These have more particularly 1 to 4 and preferably 2 to 4 hydrogen atoms reactive with alkylene oxides. The component b1aii) is particularly selected from the group comprising glycerol, monofunctional alcohols of 1-20 carbon atoms, ethylene glycol and its higher homologs and propylene glycol and its higher homologs, hydroxyalkylamines, such as monoethanolamine, diethanolamine, triethanolamine, and also reaction products thereof with propylene oxide. Glycerol is used in particular.

The room temperature liquid alcohols (b1aii), as mentioned, may also comprise compounds having a hydrogen atom reactive with alkylene oxides and 1-20 carbon atoms. Monofunctional alcohols are preferred here, such as methanol, ethanol, propanol, octanol, dodecanol.

In a further embodiment of the invention, the starter substance of component b1) comprises a mixture of at least one room temperature solid amine b1ai) and a room temperature liquid alcohol b1aii).

The room temperature solid amines b1ai) may, as stated above, preferably comprise MDA and polymeric MDA. The room temperature liquid alcohols b1aii) may then preferably comprise ethylene glycol and its higher homologs and propylene glycol and its higher homologs. The concentrations of the amine homologs in p-MDA are dependent on the process conditions. In general, the distribution (in weight percent) is as follows:

two-ring MDA: 50-80% by weight
three-ring MDA: 10-25% by weight
four-ring MDA: 5-12% by weight
five- and more highly ringed MDA: 5-12% by weight

A preferred p-MDA mixture has the composition:

two-ring MDA: 50% by weight
three-ring MDA: 25% by weight
four-ring MDA: 12% by weight
five- and more highly ringed MDA: 13% by weight

A further preferred p-MDA mixture has the composition:

two-ring MDA: 80% by weight
three-ring MDA: 10% by weight
four-ring MDA: 5% by weight
five- and more highly ringed MDA: 5% by weight

In a further preferred embodiment of the invention, the starter substance of component b1) comprises a mixture of at least one room temperature solid alcohol (b1ai)) and one room temperature liquid alcohol (b1aii)). The room temperature solid alcohols (b1ai) preferably comprise the sugar alcohols glucose, sorbitol, mannitol and sucrose more particularly characterized above, more particularly sucrose. The room temperature liquid alcohols (b1aii) preferably comprise monofunctional alcohols of 1-20 carbon atoms, ethylene glycol and its higher homologs, propylene glycol and its higher homologs, hydroxyalkylamines, such as monoethanolamine, diethanolamine, triethanolamine, and also analogs thereof based on propylene oxide, and glycerol, more particularly glycerol. The starter substance of component b1) may also comprise water. When water is used, the amount is more particularly not more than 25% by weight, based on the weight of the starter substance of component b1).

Alkylene oxide b1b) preferably comprises propylene oxide, ethylene oxide, butylene oxide, isobutylene oxide, styrene oxide and mixtures of two or more thereof. Preferably, propylene oxide, ethylene oxide or mixtures of propylene oxide and ethylene oxide are used as alkylene oxide b1b). It is particularly preferable to use propylene oxide as alkylene oxide b1b).

Catalyst b1c), as mentioned, comprises an amine other than component b1aii). This amine may comprise primary, secondary or tertiary amines and also aliphatic or aromatic, more particularly tertiary, amines. In a further embodiment, aromatic heterocyclic compounds having at least one, preferably one, nitrogen atom in the ring may be concerned.

The amines b1c) are preferably selected from the group comprising trialkylamines, more particularly trimethylamine, triethylamine, tripropylamine, tributylamine, dimethylalkylamines, more particularly dimethylethanolamine; dimethylethoxyethanolamine, dimethylcyclohexylamine, dimethylethylamine, dimethylbutylamine, aromatic amines, more particularly dimethylaniline, dimethylaminopyridine, dimethylbenzylamine, pyridine, imidazoles (more particularly imidazole, N-methylimidazole, 2-methylimidazole, 4-methylimidazole, 5-methylimidazole, 2-ethyl-4-methylimidazole, 2,4-dimethylimidazole, 1-hydroxypropylimidazole, 2,4,5-trimethylimidazole, 2-ethylimidazole, 2-ethyl-4-methylimidazole, N-phenylimidazole, 2-phenylimidazole, 4-phenylimidazole), guanidine, alkylated guanidines (more particularly 1,1,3,3-tetramethylguanidine), 7-methyl-1,5,7-triazabicyclo[4.4.0]dec-5-ene, amidines (more particularly 1,5-diazobicyclo[4.3.0]non-5-ene, 1,5-diazabicyclo[5.4.0]undec-7-ene).

It is also possible to use mixtures of at least two of the amines mentioned as catalysts.

The catalyst b1c) is dimethylethanolamine in a preferred embodiment of the invention.

The catalyst b1c) is an imidazole in a preferred embodiment of the invention.

The amine b1c) is preferably used therein in an amount of 0.01-5.0% by weight, preferably 0.05-3.0% by weight and more preferably 0.1-1.0% by weight based on the overall batch. Overall batch is to be understood as the amount of all starting compounds used for the preparation of the polyether alcohol b1).

To prepare the polyether alcohols b1), the constituents of the starter substance mixture b1a) and b1c) are typically introduced into the reactor and mixed together. Next the mixture is inertized therein. Thereafter, the alkylene oxide is metered.

The addition reaction of the alkylene oxides is preferably carried out at a temperature between 90 and 150° C. and a pressure between 0.1 to 8 bar. The metering of the alkylene oxides is typically followed by a postreaction phase to complete the reaction of the alkylene oxides.

Conclusion of the metering of the alkylene oxides is typically followed by a postreaction phase in which the reaction of the alkylene oxide is taken to completion. This is followed by a postreaction phase, if necessary. This is typically followed by distillation to remove volatiles, which is preferably carried out under reduced pressure.

The aminic catalysts b1c) can remain in the polyether alcohol. This simplifies the process of preparing them, since the removal of catalysts, which is necessary when oxides and hydroxides of alkali metals are used, is no longer necessary. This leads to an improvement in the space-time yield. The salt removal by filtration forms a filter cake. The polyol loss in the filter cake generally amounts to some percent. The improved space-time yield and avoided filter loss lead to reduced manufacturing costs.

A combination of alkali metal hydroxide catalysts and amine catalysts is also useful. This is particularly an option to prepare polyols of low hydroxyl number. The products obtained can be worked up similarly to the polyols catalyzed with alkali metal hydroxide. Alternatively, they can also be worked up by performing just the neutralization step with an acid. In this case, it is preferable to use carboxylic acids such as for example lactic acid, acetic acid or 2-ethylhexanoic acid.

The aminic catalysts b1c) can themselves be alkoxylated in the course of the reaction. The alkoxylated amines, therefore, have a higher molecular weight and reduced volatility in the later product. Owing to the remaining auto-reactivity of the alkoxylated amine catalysts, incorporation into the polymer scaffold occurs during the later reaction with isocyanates. The auto-reactivity of the tertiary amines formed endows the polyols with an auto-reactivity which can be usefully exploited in certain applications.

Without wishing to be tied to any one theory, it is believed that the polyether alcohols obtained using amines as catalysts have a construction which differs from the construction of polyether alcohols obtained using other catalysts. This different molecular construction has advantages in the manufacture of polyurethanes.

Therefore, the polyols of the invention have distinct advantages in polyurethane applications, particularly in the manufacturing process of polyurethane foams.

As mentioned, the polyether alcohols b1) are used in the manufacture of polyurethanes.

The Starting Materials Used for this May be More Particularly Described as Follows:

The organic polyisocyanates contemplated are preferably aromatic polyfunctional isocyanates.

Specific examples are: 2,4- and 2,6-tolylene diisocyanate (TDI) and the corresponding isomeric mixtures, 4,4′-, 2,4′- and 2,2′-diphenylmethane diisocyanate (MDI) and the corresponding isomeric mixtures, mixtures of 4,4′- and 2,4′-diphenylmethane diisocyanates and in the manufacture of rigid polyurethane foams particularly mixtures of 4,4′-, 2,4′- and 2,2′-diphenylmethane diisocyanates and polyphenyl polymethylene polyisocyanates (crude MDI).

The polyether alcohols b1) of the present invention are typically used in admixture with other compounds having at least two hydrogen atoms reactive with isocyanate groups.

Compounds useful together with the polyether alcohols b1) and having at least two isocyanate-reactive hydrogen atoms include particularly polyether alcohols and/or polyester alcohols having OH numbers in the range from 100 to 1200 mgKOH/g.

The polyester alcohols used together with the polyether alcohols b1) are usually prepared by condensation of polyfunctional alcohols, preferably diols, having 2 to 12 carbon atoms and preferably 2 to 6 carbon atoms, with polyfunctional carboxylic acids having 2 to 12 carbon atoms, for example succinic acid, glutaric acid, adipic acid, suberic acid, azelaic acid, sebacic acid, decanedicarboxylic acid, maleic acid, fumaric acid and preferably phthalic acid, isophthalic acid, terephthalic acid and the isomeric naphthalenedicarboxylic acids.

The polyether alcohols used together with the polyether alcohols b1) usually have a functionality between 2 and 8 and more particularly from 3 to 8.

Particular preference is given to using polyether alcohols prepared by known methods, for example by anionic polymerization of alkylene oxides in the presence of catalysts, preferably alkali metal hydroxides.

The alkylene oxides used are mostly ethylene oxide and/or propylene oxide, preferably pure 1,2-propylene oxide.

The starter molecules used are in particular compounds having at least 3 and preferably from 4 to 8 hydroxyl groups or having at least two primary amino groups in the molecule.

By way of starter molecules having at least 3 and preferably from 4 to 8 hydroxyl groups in the molecule it is preferable to use trimethylolpropane, glycerol, pentaerythritol, sugar compounds such as for example glucose, sorbitol, mannitol and sucrose, polyhydric phenols, resols, for example oligomeric condensation products of phenol and formaldehyde, condensation products of aniline and formaldehyde, toluenediamine and Mannich condensates of phenols, formaldehyde and dialkanolamines and also melamine.

The polyether alcohols have a functionality of preferably 3 to 8 and hydroxyl numbers of preferably 100 mgKOH/g to 1200 mgKOH/g and more particularly 120 mgKOH/g to 570 mgKOH/g.

By using difunctional polyols, for example polyethylene glycols and/or polypropylene glycols, having a molecular weight in the range between 500 to 1500 in the polyol component, the viscosity of the polyol component can be adapted.

The compounds having at least two isocyanate-reactive hydrogen atoms also include the optionally used chain extenders and crosslinkers. Rigid polyurethane foams can be manufactured with or without the use of chain-extending and/or crosslinking agents. The addition of difunctional chain-extending agents, trifunctional and higher-functional crosslinking agents or optionally also mixtures thereof may prove advantageous for modifying the mechanical properties. Chain-extending and/or crosslinking agents used are preferably alkanolamines and, more particularly, diols and/or triols having molecular weights of below 400, preferably in the range from 60 to 300.

Chain-extending agents, crosslinking agents or mixtures thereof are advantageously used in an amount of 1% to 20% by weight and preferably 2% to 5% by weight, based on the polyol component.

The polyurethane foams are typically manufactured in the presence of a blowing agent. The blowing agent used may preferably be water, which reacts with isocyanate groups by elimination of carbon dioxide. A further frequently used chemical blowing agent is formic acid which reacts with isocyanate by releasing carbon monoxide and carbon dioxide. So-called physical blowing agents can also be used in addition to or in lieu of chemical blowing agents. Physical blowing agents comprise usually room temperature liquid compounds which are inert toward the feed components and vaporize under the conditions of the urethane reaction. The boiling point of these compounds is preferably below 50° C. Physical blowing agents also include compounds which are gaseous at room temperature and are introduced into and/or dissolved in the feed components under pressure, examples being carbon dioxide, alkanes, more particularly low-boiling alkanes and fluoroalkanes, preferably alkanes, more particularly low-boiling alkanes and fluoroalkanes.

Physical blowing agents are usually selected from the group comprising alkanes and/or cycloalkanes having at least 4 carbon atoms, dialkyl ethers, esters, ketones, acetals, fluoroalkanes having 1 to 8 carbon atoms and tetraalkylsilanes having 1 to 3 carbon atoms in the alkyl chain, more particularly tetramethylsilane.

Examples are propane, n-butane, isobutane, cyclobutane, n-pentane, isopentane, cyclopentane, cyclohexane, dimethyl ether, methyl ethyl ether, methyl butyl ether, methyl formate, acetone, and also fluoroalkanes which can be degraded in the troposphere and therefore are harmless to the ozone layer, such as trifluoromethane, difluoromethane, 1,1,1,3,3-pentafluorobutane, 1,1,1,3,3-pentafluoropropane, 1,1,1,2,3-pentafluoropropene, 1-chloro-3,3,3-trifluoropropene, 1,1,1,2-tetrafluoroethane, difluoroethane and 1,1,1,2,3,3,3-heptafluoropropane, and also perfluoroalkanes, such as C3F8, C4F10, C5F12, C6F14, and C7F17. Particular preference is given to hydrocarbons, preferably pentanes, more particularly cyclopentane. The physical blowing agents mentioned can be used alone or in any desired combination with one another.

A mixture of physical and chemical blowing agents can be used in a preferred embodiment of the invention. Particular preference is given to mixtures of physical blowing agents and water, more particularly hydrocarbons and water. Among hydrocarbons it is the pentanes—and of these especially cyclopentane—which are particularly preferred.

Manufacturing polyurethanes may be effected, if necessary, in the presence of catalysts, flame retardants and also customary auxiliary and/or added substances.

Further particulars concerning the starting compounds used may be found for example in Kunststoffhandbuch, volume 7 “Polyurethane”, edited by Günter Oertel, Carl-Hanser-Verlag Munich, 3rd edition, 1993.

The rigid PU foams are preferably used as thermally insulating intermediate layer in composite elements and for filling hollow spaces in refrigeration appliance housings, more particularly refrigerators and chest freezers with foam and as outer casing of hot water storage tanks. The products are further useful for insulating heated materials, as engine cowling and as pipe shells.

Their use particularly in the manufacture of composite or sandwich elements constructed from a rigid PU foam and at least one outside layer of a rigid or elastic material such as paper, polymeric film, aluminum foil, metal sheets, glass veils or particle board is known. Also known is the filling of hollow spaces in household appliances such as refrigerating appliances, for example refrigerators or chest freezers or of hot water storage systems, with rigid PU foam as thermal insulant. Further uses are insulated pipes consisting of an inside pipe of metal or plastic, an insulating polyurethane layer and an outside jacket of polyethylene. Insulation is further possible for large storage containers or transportation ships, for example for storage and transportation of liquids or liquefied gases in the temperature range from 160° C. to −160° C. Heat- and cold-insulating rigid PU foams suitable for these purposes, as will be known, are obtainable by reaction of organic polyisocyanates with one or more compounds having at least two isocyanate-reactive groups, preferably polyester- and/or polyether-polyols, and also typically by co-use of chain-extending agents and/or crosslinking agents in the presence of blowing agents, catalysts and optionally auxiliaries and/or added substances. An appropriate choice of reactive components makes it possible to obtain rigid PU foams having a low thermal conductivity index and good mechanical properties.

A summarizing overview of the production of rigid PU foams and their use as outside layer or preferably central layer in composite elements and their use as insulating layer in refrigerating or heating technology was published for example in Polyurethane, Kunststoff-Handbuch, volume 7, 3rd edition 1993, edited by Dr. Günter Oertel, Carl Hanser Verlag, Munich, Vienna.

The examples which follow illustrate the invention.

### Polyol Syntheses

### EXAMPLE 1

### Preparing the Polyols of the Invention: 2, 3 and 5

### Polyol 2

A 250 I pressure reactor equipped with stirrer, jacket heating and cooling, metering devices for solid and liquid substances and alkylene oxides and also devices for nitrogen inertization and a vacuum system was heated to 80° C. and repeatedly inertized. 18.38 kg of glycerol and 1.26 kg of DMEOA were poured in and the stirrer was started. Then, sucrose (191.6 kg) was introduced into the reactor and the temperature was raised to 95° C. The mixture was reacted with 54.0 kg of propylene oxide at 95° C. Following an after-reaction time of 30 minutes, a further 0.64 kg of DMEOA was added. The temperature was then raised to 112° C. and 116 kg of propylene oxide were added. The after-reaction of 3 hours took place at 112° C. The product was stripped at 105° C. (vacuum, nitrogen) for 2 h to obtain 352 kg of product having the following parameters:

| | | |
|---|---|---|
| Hydroxyl number | 444 | mg KOH/g |
| Viscosity | 15300 | mPas |

| | |
|---|---|
| Water content | 0.013% |
| pH | 9.7 |

### Polyol 3

A 600 I pressure reactor equipped with stirrer, jacket heating and cooling, metering devices for solid and liquid substances and alkylene oxides and also devices for nitrogen inertization and a vacuum system was heated to 80° C. and repeatedly inertized. 58.2 kg of glycerol and 6.0 kg of dimethylethanolamine were introduced into the reactor and the stirrer was started. Then, sucrose (191.6 kg) was introduced into the reactor and the temperature was raised to 95° C. The mixture was reacted with 195.0 kg of propylene oxide at 105° C. The temperature was then raised to 112° C. and the product was reacted with a further 352.7 kg of propylene oxide. The after-reaction of 3 hours took place at 112° C. The propylene oxide still present was stripped off in a stream of nitrogen to obtain 770 kg of product having the following parameters:

| | | |
|---|---|---|
| Hydroxyl number | 455 | mg KOH/g |
| Viscosity | 14800 | mPas |

| | |
|---|---|
| Water content | 0.03% |
| pH | 9.8 |

### Polyol 5

A 600 I pressure reactor equipped with stirrer, jacket heating and cooling, metering devices for solid and liquid substances and alkylene oxides and also devices for nitrogen inertization and a vacuum system was heated up to 75° C. and repeatedly inertized. 47.00 kg of glycerol and 3.09 kg of dimethylethanolamine were introduced and the stirrer was started. Then, sucrose (154.75 kg) was introduced into the reactor and 157.50 kg of PO were metered in at 75° C. to 95° C.

Following reaction of 30 minutes at 105° C., a further 1.55 kg of DMEOA were added and 254.50 kg of PO were metered in. The after-reaction of 2 hours took place at 105° C. The propylene oxide still present was stripped off in a stream of nitrogen to obtain 593 kg of the product.

| | | |
|---|---|---|
| Hydroxyl number | 468 | mg KOH/g |
| Viscosity | 21300 | mPas |

| | |
|---|---|
| Water content | 0.016% |
| pH | 10.2 |

### EXAMPLE 2

### Preparing the Comparative Polyols: 1 and 4

### Polyol 1:

A 50 I pressure reactor equipped with stirrer, jacket heating and cooling, metering devices for solid and liquid substances and alkylene oxides and also devices for nitrogen inertization and a vacuum system was heated up to 90° C. and repeatedly inertized. 2.87 kg of glycerol, 0.188 kg of 48% KOH solution and 0.065 kg of water were introduced and the stirrer was started. Then, sucrose (9.48 kg) was added. The temperature was raised to 105° C. and 7.53 kg were added. Following a reaction time of 1 h the temperature was raised to 112° C. and the remaining PO (19.85 kg) was metered in. The polyetherol obtained was hydrolyzed with water, neutralized with phosphoric acid, filtered and vacuum stripped to obtain 39.1 kg of the product.

| | | |
|---|---|---|
| Hydroxyl number | 450 | mg KOH/g |
| Viscosity | 19500 | mPas |

| | |
|---|---|
| Water content | 0.07% |
| pH | 9.2 |

### Polyol 4

A 50 I pressure reactor equipped with stirrer, jacket heating and cooling, metering devices for solid and liquid substances and alkylene oxides and also devices for nitrogen inertization and a vacuum system was heated up to 90° C. and repeatedly inertized. 4.00 kg of glycerol, 0.245 kg of 48% KOH solution and 0.049 kg of water were introduced and the stirrer was started. Then, sucrose (13.16 kg) was added and 11.7 kg of PO were metered in at 105° C. Following an after-reaction of 3 h the temperature was raised to 112° C. and the remaining PO (22.3 kg) was metered in. The polyetherol obtained was hydrolyzed with water, neutralized with phosphoric acid, filtered and vacuum stripped to obtain 41.5 kg of the product.

| | | |
|---|---|---|
| Hydroxyl number | 477 | mg KOH/g |
| Viscosity | 22300 | mPas |
| Acid number | 0.012 | mg KOH/g |

| | |
|---|---|
| Water content | 0.023% |
| pH | 10.2 |

### Methods:

### Viscosity Measurements:

The viscosity of the polyols and of the polyol mixtures, unless otherwise stated, was determined at 25° C. using a Rheotec RC 20 rotary viscometer with spindle CC 25 DIN (spindle diameter: 12.5 mm; measuring cylinder internal diameter: 13.56 mm) at a shear rate of 50 1/s.

### Hydroxyl Numbers

Hydroxyl numbers were determined according to DIN 53240.

### Thermal Conductivity:

Thermal conductivity was determined according to DIN 52616. To produce the test specimens, the polyurethane reaction mixture was poured into a mold measuring 200×20×5 cm (10% overfill) and after some hours any test specimen measuring 20×20×2 cm was cut out of the middle.

### Compressive Strength:

Compressive strength was determined according to DIN 53421/DIN EN ISO 604.

### Determination of Pentane Solubility:

50 g of polyol or polyol mixture are introduced into a 100 mL glass vessel. A quantity of cyclopentane is added. Thereafter, the glass vessel is sealed, shaken vigorously for 5 minutes and then left to stand for one hour. Thereafter, the appearance of the sample is inspected. When the sample is clear, the test is repeated with more cyclopentane. When the mixture is cloudy, the test is repeated with less cyclopentane. In this way, the maximum amount of cyclopentane soluble in the polyol or polyol mixture is determined. This amount is the pentane solubility of the polyol or polyol mixture. The accuracy of this method is 1%.

### Foam Production for Mechanical Testing:

The foaming experiments were carried out using the following base formulation:

100 parts by weight of polyol (or polyol mixture)
2.4 parts by weight of stabilizer (Tegostab® B 8467 from Evonik)
0.85 part of water
dimethylcyclohexylamine
cyclopentane
polymeric MDI (Lupranat M20® from BASF SE)

The foams are produced at an isocyanate index of 100. The quantities of dimethylcyclohexylamine and cyclopentane were determined such that, in a beaker test involving 50 g total initial weight, a stirring time of 10 s and also a setting time of 55 s, a free-foamed raw density of 35 g/L was obtained. In a second test, the components were intensively mixed together by means of a laboratory stirrer and introduced into a cube-shaped steel mold for foaming (500 g of reaction mixture, mold volume: 11.4 L). The fully reacted foam samples were demolded after 20 min and stored for a further 3 days under standard conditions. Density was determined to ISO 845 and compressive strength to ISO 604.

Table 1 gives an overview of the polyols used.

TABLE 1
Overview of polyols used and pentane solubilities

| | | | | Pentane | |
|---|---|---|---|---|---|
| | Construction, average | | OH number | solubility | Viscosity |
| Polyol | functionality | Catalysis | [mg KOH/g] | [%] | [mPas] |
| 1 (V) | sucrose/glycerol/PO, | KOH | 450 | 8 | 19500 |
| | Fn = 5.1 | | | | |
| 2 | sucrose/glycerol/PO, | DMEOA | 444 | 13 | 15300 |
| | Fn = 5.1 | | | | |
| 3 | sucrose/glycerol/PO, | DMEOA | 455 | 13 | 14800 |
| | Fn = 5.2 | | | | |
| 4 (V) | sucrose/glycerol/PO, | KOH | 477 | 10 | 22300 |
| | Fn = 5.1 | | | | |
| 5 | sucrose/glycerol/PO, | DMEOA | 468 | 11 | 21300 |
| | Fn = 5.1 | | | | |
| 6 | dipropylene glycol | KOH | 837 | not relevant | n.r. |
| | | | | (n.r.) | |
| 7 | glycerol/PO | KOH | 230 | n.r. | n.r. |
| 8 | TDA/EO/PO | KOH | 160 | n.r. | n.r. |

(V = comparative examples)
Fn: average functionality

Table 2 presents a comparison of the properties of a system based on sucrose-polyol.

TABLE 2
Foam formulations based on sucrose-based polyols

| | | 1 (V) | 2 |
|---|---|---|---|
| polyol 1 | [pbw] | 100 | |
| polyol 2 | [pbw] | | 100 |
| cyclopentane | [pbw] | 17.3 | 16.0 |
| dimethylcyclohexylamine | [pbw] | 6.0 | 5.3 |
| viscosity of mixture | [mPas] | 19500 | 15300 |
| pentane solubility of mixture | [%] | 8 | 13 |
| beaker test | | | |
| fiber time | [s] | 58 | 56 |
| raw density | [kg/m³] | 36.8 | 37.0 |
| cube | | | |
| compressive strength | N/mm² | 0.28 | 0.28 |
| core density | kg/m³ | 34.1 | 35.0 |

(V = comparative example)
pbw—parts by weight

Tables 3 and 4 give an overview of the systems obtained with polyol mixtures.

TABLE 3
Foam formulations based on polyol mixtures in which sucrose-
based polyols are the main constituent of the mixture

| | | 3 (V) | 4 |
|---|---|---|---|
| polyol 1 | [pbw] | 65 | |
| polyol 2 | [pbw] | | 65 |
| polyol 7 | [pbw] | 27 | 27 |
| polyol 6 | [pbw] | 8 | 8 |
| dimethylcyclohexylamine | [pbw] | 5.2 | 4.0 |
| cyclopentane | [pbw] | 14.5 | 13.6 |
| pentane solubility of mixture | [%] | 21 | 23 |
| viscosity of mixture | [mPas] | 2690 | 2300 |
| beaker test | | | |
| fiber time | [s] | 52 | 56 |
| raw density | [kg/m³] | 35.2 | 35.6 |
| cube | | | |
| compressive strength | [N/mm²] | 0.24 | 0.23 |
| core density | [kg/m³] | 36.1 | 37.0 |

(V = comparative example)

TABLE 4
Foam formulations based on polyol mixtures in which sucrose-
based polyols are the main constituent of the mixture

| | | 5 | 6 | 7 (V) | 8 (V) |
|---|---|---|---|---|---|
| Polyol 4 | [pbw] | 80 | | 82 | |
| Polyol 5 | [pbw] | | 80 | | 82 |
| Polyol 6 | [pbw] | 9 | 9 | 8 | 8 |
| Polyol 7 | [pbw] | | | 10 | 10 |
| Polyol 8 | [pbw] | 11 | 11 | | |
| dimethylcyclo- | [pbw] | 5.0 | 3.8 | 5.0 | 4.3 |
| hexylamine | | | | | |
| cyclopentane | [pbw] | 15.5 | 15.1 | 15.5 | 14.7 |
| pentane solubility | [%] | 13 | 14 | 11 | 15 |
| of mixture | | | | | |
| viscosity of mixture | [mPas] | 6800 | 6480 | 6300 | 6100 |
| beaker test | | | | | |
| fiber time | [s] | 53 | 57 | 54 | 54 |
| raw density | [kg/m³] | 35.4 | 35.4 | 35.6 | 35.8 |
| cube | | | | | |
| compressive strength | [N/mm²] | 0.29 | 0.26 | 0.29 | 0.26 |
| core density | [kg/m³] | 36.9 | 36.1 | 37.5 | 36.2 |

(V = comparative example)

### Comments Concerning Tables 2-4:

The amine-catalyzed polyols exhibit better utilization of the cyclopentane used as blowing agent. A foam having the same raw density can be produced using a smaller quantity of cyclopentane. Owing to the autocatalytic properties of the amine-catalyzed polyols, the amount of catalyst used can be reduced. Improved pentane solubility and reduced viscosity were obtained not just from the exclusive use of the amine-catalyzed polyols (table 2), but also from mixtures comprising such polyols (tables 3 and 4). The mechanical properties are the same.

### Machine Foaming:

The stated raw materials were used to prepare a polyol component. The polyol component was mixed with the requisite amount of the stated isocyanate in a high pressure Puromat® HD30 (Elastogran GmbH) to obtain an isocyanate index of 110. The reaction mixture was injected into molds measuring 200 cm×20 cm×5 cm or 40 cm×70 cm×9 cm and allowed to foam up therein. The properties and parameters of the foams are reported in tables 5 and 6.

TABLE 5
Foam composition for machine foaming

| | | 9 (V) | 10 |
|---|---|---|---|
| polyol 1 | [pbw] | 63.45 | — |
| polyol 3 | [pbw] | — | 63.45 |
| polyol 8 | [pbw] | 25.00 | 25.00 |
| polyol 6 | [pbw] | 5.00 | 5.00 |
| silicone stabilizer | [pbw] | 2.00 | 2.00 |
| Polycat 8 (Air Products) | [pbw] | 0.60 | 0.60 |
| Polycat 5 (Air Products) | [pbw] | 0.90 | 0.90 |
| Polycat 41 (Air Products) | [pbw] | 0.55 | 0.55 |
| water | [pbw] | 2.50 | 2.50 |
| cyclopentane/isopentane (70/30) | [pbw] | 13.00 | 13.00 |

TABLE 6
Properties

| | | 9 (V) | | | 10 | | |
|---|---|---|---|---|---|---|---|
| Polyol component viscosity | [mPas] @ 25° C. | 4600 | | | 4000 | | |
| pentane solubility | [° C.] | 10 | | | 8 | | |
| postexpansion @ 3 min | [mm] @ OP 11, 14, 17% | 4.5 | 4.9 | 5.5 | 4.2 | 4.9 | 5.1 |
| postexpansion @ 4 min | [mm] @ OP 11, 14, 17% | 3.2 | 3.6 | 4.3 | 2.9 | 3.5 | 3.8 |
| postexpansion @ 5 min | [mm] @ OP 11, 14, 17% | 2.2 | 2.6 | 3.2 | 1.9 | 2.5 | 2.8 |
| postexpansion @ 7 min | [mm] @ OP 11, 14, 17% | 1.3 | 1.6 | 1.9 | 0.9 | 1.2 | 1.7 |
| lambda value | [mW/m*K] | 20.5 | | | 20.0 | | |
| compressive strength at | [N/mm²] at core | 0.15/33.9 | 0.16/34.9 | 0.17/35.9 | 0.15/33.8 | 0.16/34.8 | 0.17/35.8 |
| overpacking 11, 14, 17% | density [g/L] | | | | | | |

| flow factor | 1.34 | 1.29 |
|---|---|---|
| surface quality | 0 | + |

Postexpansion was determined using a box mold measuring 70×40×9 cm as a function of demolding time and degree of overpacking (OP) by measuring the heights of the boxes after 24 h. Surface quality was determined by visually determining the frequency and intensity of surface disruptions (0=reference, +=lower number of disruptions and also lower intensity of surface disruptions compared with reference).

### Summary of Results

### Comments Concerning Tables 5 and 6:

Although functionality and OH number are the same, the viscosity of the DMEOA-catalyzed polyol is lower by 3000 mPas. This is significant and also manifests in a likewise lower viscosity of the polyol component and also in the flow factor and an improved surface quality (reduced number of void spaces). All other properties important for rigid foams for this use are comparable.

We claim:

1. A process for preparing rigid polyurethane foams, which comprises reacting
a) polyisocyanates with
b) compounds having at least two hydrogen atoms reactive with isocyanate groups in the presence of
c) blowing agents,
wherein said compounds having at least two hydrogen atoms reactive with isocyanate groups b) comprise at least one polyether alcohol b1) having a functionality of 2-8 and a hydroxyl number of 200-800 mgKOH/g, obtained by addition of an alkylene oxide b1b) onto a compound having at least two hydrogen atoms b1a), hereinafter also known as starter substances, reactive with alkylene oxides by using an amine b1c) as catalyst.

2. The process according to claim 1 wherein said polyether alcohol b1) is used in an amount of 10-90% by weight, based on the weight of said component b).

3. The process according to claim 1 wherein said compound b1a) having at least two hydrogen atoms reactive with alkylene oxides used for preparing said polyether alcohol b1) comprises a mixture comprising at least one compound b1ai) which is solid at room temperature.

4. The process according to claim 1 wherein said compound b1ai) is selected from the group comprising pentaerythritol, glucose, sorbitol, mannitol, sucrose, polyhydric phenols, resols, condensates of aniline and formaldehyde, toluenediamine, Mannich condensates of phenols, formaldehyde and dialkanolamines, melamine and also mixtures of at least two of the recited compounds.

5. The process according to claim 1 wherein said compound b1ai) is selected from the group comprising sucrose, sorbitol and pentaerythritol.

6. The process according to claim 1 wherein said compound b1a) having at least two hydrogen atoms reactive with alkylene oxides used for preparing said polyether alcohol b1) comprises a mixture comprising at least one compound b1aii) which is liquid at room temperature.

7. The process according to claim 1 wherein said compound b1aii) is selected from the group comprising glycerol, monofunctional alcohols of 1-20 carbon atoms, ethylene glycol and its higher homologs and propylene glycol and its higher homologs, hydroxyalkylamines, such as monoethanolamine, diethanolamine, triethanolamine, and also reaction products thereof with propylene oxide.

8. The process according to claim 1 wherein said compound b1a) comprises a mixture of at least one compound b1ai) which is solid at room temperature and at least one compound b1aii) which is liquid at room temperature.

9. The process according to claim 1 utilizing an amine other than an amine of b1ai) as said catalyst b1c).

10. The process according to claim 1 wherein said catalyst b1c) is selected from the group comprising trialkylamines, aromatic amines, pyridine, imidazoles, guanidines, alkylated guanidines, amidines.

11. The process according to claim 1 wherein said catalyst b1c) is dimethylethanolamine.

12. The process according to claim 1 wherein said catalyst b1c) is imidazole.

13. The process according to claim 1 wherein said catalyst b1c) is used in an amount of 0.01-5.0%, preferably 0.05-3.0% and more preferably 0.1-1.0% by weight, based on the total batch, for preparing said component b1).

14. The process according to claim 1 utilizing hydrocarbons as blowing agent.

15. A rigid polyurethane foam obtainable according to any of claims 1-14.
